(19) United States
(12) Patent Application Publication
(10) Pub. No.: US 2011/0312222 A1
(43) Pub. Date: Dec. 22, 2011

(54) MULTI-ELECTRODE HOLDERS

(76) Inventor: Yokichi J. Tanaka, Foothill Ranch, CA (US)

(21) Appl. No.: 13/161,884

(22) Filed: Jun. 16, 2011

Related U.S. Application Data
(60) Provisional application No. 61/355,395, filed on Jun. 16, 2010.
(60) Provisional application No. 61/420,192, filed on Dec. 6, 2010.

(51) Int. Cl. H01R 24/00

(52) U.S. Cl. 439/626

(57) ABSTRACT

Various embodiments of a multi-electrode holder are described. In one embodiment, the multi-electrode holder is employed to electrically connect a plurality of replaceable electrodes to a cable. In this embodiment, the multi-electrode holder includes a substrate, a plurality of independently actuatable contacts, and a connector, for connection to a cable, in electrical communication with the plurality of contacts. A plurality of channels may be formed in the substrate to receive at least two electrodes. In such a case, each contact may be aligned with a channel to retain an electrode disposed therein and to make electrical contact with such electrode. Alternatively, a plurality of electrode through-holes, for receiving electrodes, may be formed through the substrate. In this case, one end of a given electrode is retained by a contact and makes electrical contact therewith, while the other end of the electrode extends through an electrode through-hole.

### CROSS-REFERENCE TO RELATED APPLICATIONS

This application claims priority to and the benefit of, and incorporates herein by reference in their entireties, U.S. Provisional Patent Application No. 61/355,395, which was filed on Jun. 16, 2010, and U.S. Provisional Patent Application No. 61/420,192, which was filed on Dec. 6, 2010.

### TECHNICAL FIELD

In various embodiments, the present invention relates to multi-electrode holders.

### BACKGROUND

Electrodes are employed in a variety of applications. For example, in electrophysiological experiments, one or more sensing electrode(s), located within a test head, may be employed to measure a characteristic of one or more biological cell(s), such as the current flowing through its/their membrane(s). Within the test head, a holder device is typically employed to hold the electrodes in place. But, the electrodes, which may be made from, for example, platinum or silver/silver chloride, are typically expensive and need to be replaced periodically due to oxidation. Accordingly, in applications requiring the use of multiple electrodes, it would be desirable to be able to remove and replace individual electrodes, rather than having to replace the entire set of electrodes when one electrode fails.

An exemplary single electrode holder 100 is illustrated in FIG. 1. Single electrode holders 100 are, however, expensive, and in applications requiring multiple electrodes they are generally too wide to be grouped to fit into a multi-electrode array configuration. U.S. Pat. No. 6,993,392 and U.S. Patent Application Publication No. 2005/0231186, the disclosures of which are hereby incorporated herein by reference in their entireties, describe other exemplary electrode holders, but these too suffer from a variety of disadvantages, including the fact that they are not configured to permit removal and replacement of individual electrodes.

Accordingly, there is a need for an improved multi-electrode holder.

### SUMMARY OF THE INVENTION

In various embodiments, the present invention features a multi-electrode holder in which each electrode may be individually removed and replaced—the electrodes do not all need to be removed and replaced at the same time.

In general, in one aspect, embodiments of the invention feature a multi-electrode holder adapted for use to electrically connect a plurality of replaceable electrodes to a cable. The multi-electrode holder includes a substrate having a plurality of channels formed therein for receiving at least two electrodes, a plurality of independently actuatable contacts, and a connector in electrical communication with the plurality of contacts for connection to a cable. Each contact may be aligned with a channel for retaining an electrode when disposed therein and for making electrical contact with such electrode.

In various embodiments, the substrate includes an upper substrate surface and a lower substrate surface, which may be clamped together. The channels may be formed between the upper and lower substrate surfaces, and each channel may be adapted to receive an electrode therein. Each channel may be sized to receive an electrode in close fitting sliding relation and in electrical isolation from other channels. In addition, the channels may have a pitch spacing therebetween of no more than about 0.2 inches, which is about 5.1 mm. For example, in some embodiments, the channels have a pitch spacing therebetween of about 0.177 inches (i.e., about 4.5 mm).

In one embodiment, at least one contact of the plurality of independently actuatable contacts utilizes friction to maintain a clamping force on an electrode when the electrode is disposed in an associated channel. The at least one contact may include, for example, a threaded fastener (such as a screw) for this purpose. The connector may be in electrical communication with the plurality of contacts using conductive traces formed on the substrate.

In one embodiment, the multi-electrode holder further includes at least two electrodes disposed in their respective channels. The electrodes may be made from, for example, platinum or silver/silver chloride.

In general, in another aspect, embodiments of the invention feature a multi-electrode holder adapted for use to electrically connect a plurality of replaceable electrodes to an amplifier cable. The multi-electrode holder includes a substrate having an upper board and a lower board. At least one of the upper board and the lower board has a plurality of substantially parallel closely spaced channels formed therein, each of which is capable of receiving an electrode. In some embodiments, an electrode is in fact disposed in each such channel. The multi-electrode holder further includes a plurality of independently actuatable threaded contacts mounted to the substrate, where each threaded contact is aligned with a channel. Each threaded contact is capable of retaining an electrode when disposed in the channel and of making electrical contact with such an electrode. In addition, the multi-electrode holder includes a connector, which is mounted to the substrate and which has a plurality of electrical contacts for mating with a cable. The multi-electrode holder also has a plurality of conductive paths that provide isolated electrical communication between respective threaded contacts and connector electrical contacts.

In general, in yet another aspect, embodiments of the invention feature a multi-electrode holder adapted for use to electrically connect a plurality of replaceable electrodes to a cable. The multi-electrode holder includes a substrate having a plurality of electrode through-holes formed therethrough for receiving at least two electrodes, a plurality of independently actuatable contacts, and a connector in electrical communication with the plurality of contacts for connection to a cable. Each of the contacts is capable of retaining an electrode and of making electrical contact with such an electrode.

In various embodiments, the plurality of electrode through-holes are patterned to receive the electrodes in electrical isolation from each other. At least one of the actuatable contacts may be, for example, a threaded fastener (such as a screw), and the connector may be in electrical communication with the plurality of contacts using conductive traces formed on the substrate. In one embodiment, the multi-electrode holder further includes the at least two electrodes. Each electrode may be made from, for example, platinum or silver/silver chloride.

These and other objects, along with advantages and features of the embodiments of the present invention herein disclosed, will become more apparent through reference to the following description, the accompanying drawings, and the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 illustrates an exemplary single electrode holder;

FIG. 2 illustrates a multi-electrode holder, according to an embodiment of the invention;

FIG. 3 illustrates a multi-electrode holder that employs nuts, according to an embodiment of the invention;

FIG. 4 illustrates a multi-electrode holder that employs metal traces, according to an embodiment of the invention;

FIG. 5 is an exploded view of a multi-electrode holder that employs a slotted cover, according to an embodiment of the invention;

FIG. 6 illustrates a multi-electrode holder, according to an embodiment of the invention;

FIG. 7 is an exploded view of a multi-electrode holder, according to an embodiment of the invention;

FIG. 8 is an exploded view of a multi-electrode holder that employs a shallow-grooved cover, according to an embodiment of the invention;

FIG. 9 is an exploded view of a multi-electrode holder that employs a single printed circuit board (“PCB”), according to an embodiment of the invention;

FIG. 10 is an exploded view of a multi-electrode holder that employs two PCBs, according to an embodiment of the invention;

FIGS. 11A and 11B illustrate top and side views, respectively, of the lower PCB of FIG. 10, according to an embodiment of the invention;

FIG. 12 illustrates a multi-electrode holder that features a hexagonal matrix configuration, according to an embodiment of the invention; and

FIGS. 13A-13I illustrate multi-electrode holders that feature various matrix configurations, according to embodiments of the invention.

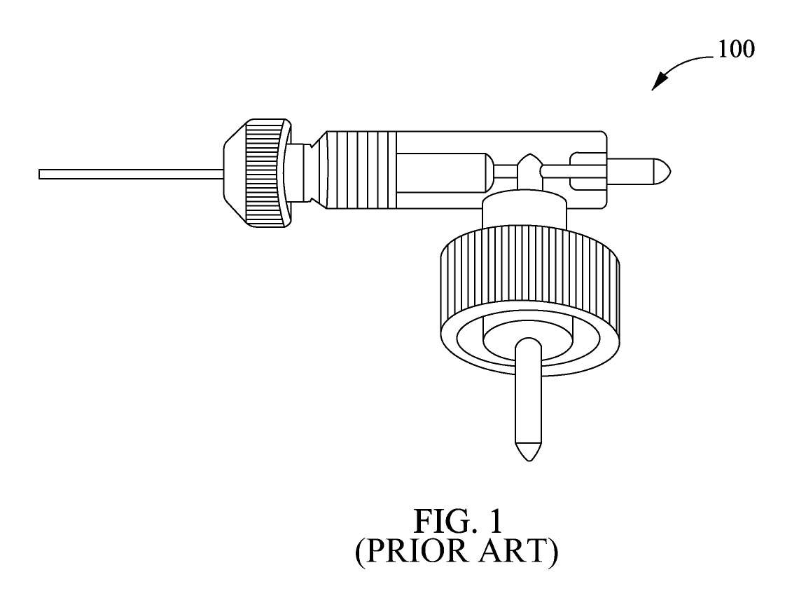

### DESCRIPTION

In various embodiments, the present invention features a multi-electrode holder in which each electrode may be individually removed and replaced—the electrodes do not all need to be removed and replaced at the same time.

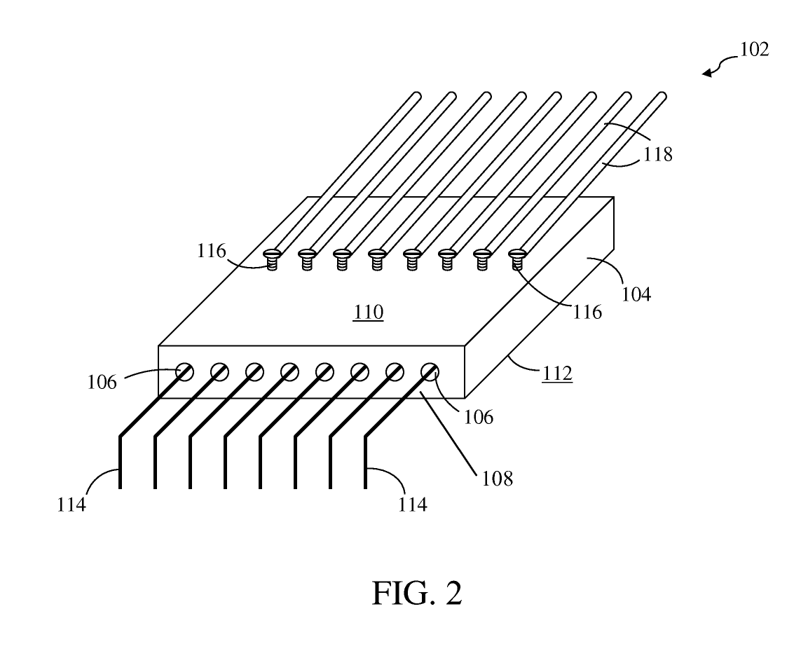

For example, FIG. 2 illustrates a multi-electrode holder 102 according to a first embodiment of the invention. The multi-electrode holder 102 includes a substrate 104 having a plurality of channels 106 formed through a side 108 thereof. The substrate 104 includes an upper substrate surface 110 and a lower substrate surface 112. As illustrated, the channels 106 are formed between the upper substrate surface 110 and the lower substrate surface 112. The upper substrate surface 110 and the lower substrate surface 112 may be clamped together by any suitable method known in the art. The channels 106 may receive a plurality of electrodes 114 therein. Specifically, as illustrated in FIG. 2, each of the channels 106 may receive a single electrode 114.

In addition, the upper substrate surface 110 may feature a plurality of independently actuatable contacts 116 (e.g., threaded fasteners, such as screws, screwed in to threaded through-holes). As illustrated, each independently actuatable contact 116 may be aligned with a single channel 106. The independently actuatable contacts 116 may be employed to retain the electrodes 114 disposed in their respective channels 106. In an exemplary embodiment, one of the independently actuatable contacts 116 utilizes friction to maintain a clamping force on an electrode 114 when the electrode 114 is disposed in its associated channel 106. Moreover, the independently actuatable contacts 116 may make electrical contact with the electrodes 114 when those electrodes 114 are disposed in their respective channels 106.

In one embodiment, as illustrated in FIG. 2, an electrode 114 may be clamped to a bottom surface of its respective channel 106 by tightening the screw 116 corresponding thereto so that the screw 116 makes physical and electrical contact with the electrode 114. When one of the electrodes 114 requires replacement (e.g., due to oxidation thereof), the respective screw 116 may be loosened and the electrode 114 may be removed and replaced. Advantageously, each electrode 114 may thus be individually removed and replaced—the electrodes 114 do not all need to be removed and replaced at the same time.

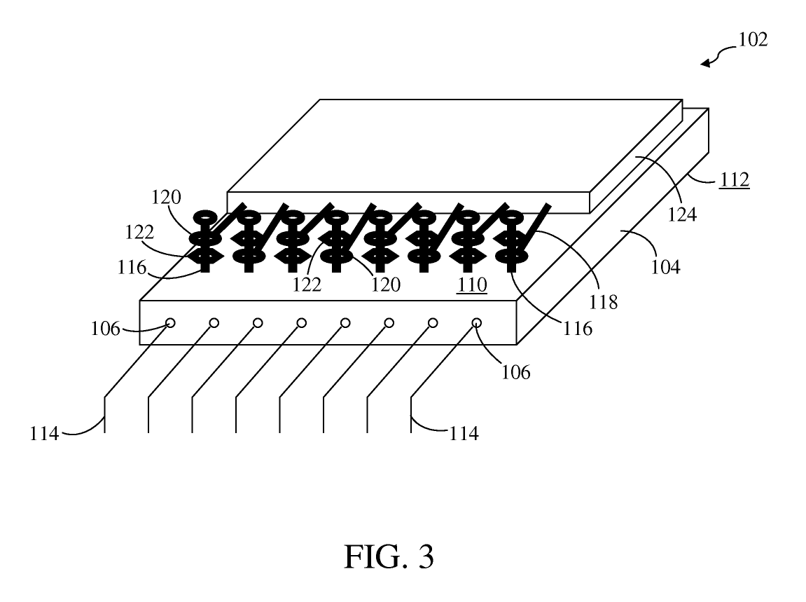

Further, each screw 116 may be electrically coupled to a wire 118. As illustrated in FIG. 3, each wire 118 may be soldered onto a washer 120 encircling a screw 116. Each screw 116 may also be encircled by a nut 122. The nut 122 may either be tightened up or tightened down onto the washer 120 to electrically couple the screws 116 with the wires 118. For example, if the nut 122 is placed below the washer 120, then the nut 122 may be tightened up onto the washer 120. Alternatively, if the nut 122 is placed above the washer 120, then the nut 122 may be tightened down onto the washer 120. As will be understood by those of ordinary skill in the art, however, any method known in the art can be employed to electrically couple the screws 116 with the wires 118. The exemplary embodiment illustrated in FIG. 3 is non-limiting. In one embodiment, the wires 118 are themselves connected to a cable connector 124, which in turn may be connected to an amplifier through a cable. Alternatively, the wires 118 may be connected to the amplifier by any other means known in the art.

In practice, the exemplary embodiment of the multi-electrode holder 102 illustrated in FIGS. 2 and 3 (and, also, each other embodiment of the multi-electrode holder 102 described herein) may be employed in a test head of a patch clamp system. More specifically, the electrodes 114 may be employed to sense the electrical behavior of biological cells and cell membranes, and the readings from the electrodes 114 may be communicated through the electrically conductive independently actuatable contacts 116 and wires 118 to the amplifier for amplification and analysis thereat. For example, in electrophysiological experiments, the electrical measurements may be made in order to understand interactions between specific membrane components. Such measurements may be performed on living cells, membranes, and/or vesicles, as well as on artificial membranes.

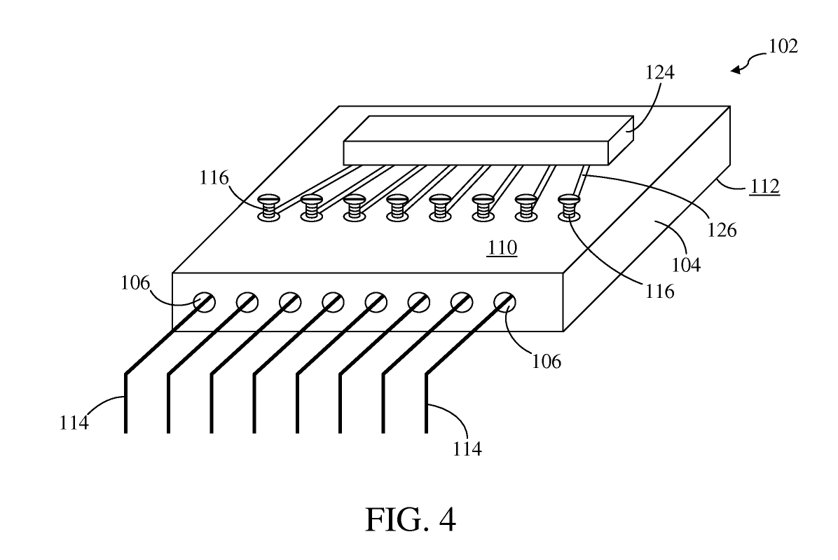

FIG. 4 illustrates a multi-electrode holder 102 that employs metal traces 126, according to an embodiment of the invention. In the exemplary embodiment of FIG. 4, the substrate 104 is a PCB having thickness of approximately 0.125 inches (i.e., 125 mils). The PCB 104 employs conductive (e.g., metal) traces 126 on the upper substrate surface 110. As explained above with reference to the previous figures, the independently actuatable contacts 116 (e.g., screws 116) may be employed to retain the electrodes 114 in their respective channels 106 and to make electrical contact with the electrodes 114. For their part, the metal traces 126 may provide an electrical interface between the screws 116 and electrical contacts of the cable connector 124, which may itself communicate with the amplifier through a cable. In an exemplary embodiment, the nuts 122 may still be employed to complete the electrical connection between the screws 116 and the metal traces 126. Thus, as illustrated in the exemplary embodiment of FIG. 4, the metal traces 126 may replace the washers 120 and the wires 118 of FIG. 3 to provide an interface with the cable connector 124.

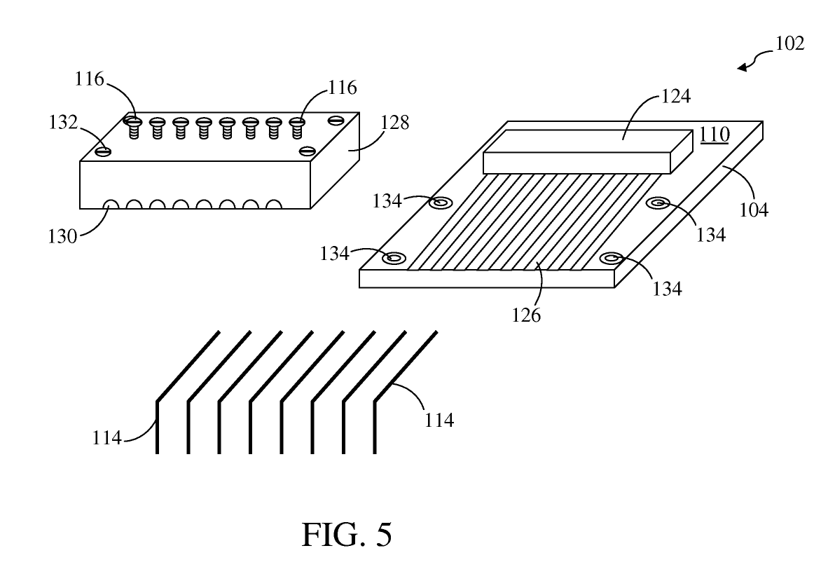

FIG. 5 is an exploded view of a multi-electrode holder 102 that employs a slotted cover 128, according to an embodiment of the invention. In the exemplary embodiment of FIG. 5, the electrodes 114 may be positioned in direct contact with the metal traces 126 formed on the upper substrate surface 110 of the substrate (e.g., PCB) 104. Further, to maintain the electric connection between the metal traces 126 and the electrodes 114, the slotted cover 128 may then be placed thereover, and screwed (or otherwise fastened) in place. The slotted cover 128 may have one or more threaded screw holes 132 corresponding to one or more receiving holes 134 in the upper substrate surface 110 of the substrate 104. In addition, the slotted cover 128 may have slots 130. Each slot 130 may feature a slot width corresponding to a width of a metal trace 126. The slots 130 may receive the electrodes 114 so that direct contact may be provided between the electrodes 114 and the metal traces 126. More specifically, as illustrated in FIG. 5, individual screws 116 in the slotted cover 128 may be aligned with the metal traces 126 and tightened to clamp each electrode 114 to its corresponding metal trace 126. No nuts 122 need to be employed to complete the electrical connection, as the electrodes 114 are in direct contact with the metal traces 126.

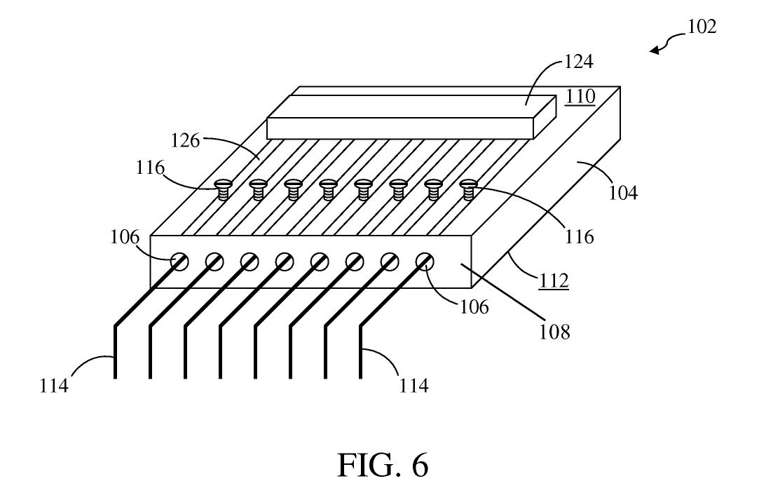

FIG. 6 illustrates a multi-electrode holder 102, according to another embodiment of the invention. In the exemplary embodiment of FIG. 6, electrodes 114 are placed in individual channels 106 formed into a side 108 of a PCB 104. Metal traces 126 are formed on an upper substrate surface 110 of the PCB 104, in alignment with the underlying channels 106. As illustrated in FIG. 6, threaded holes may be formed through the upper substrate surface 110 of the PCB 104 and screws 116 may be threaded therein to clamp each electrode 114 to the bottom surface of its associated channel 106. In addition, the screws 116 may electrically connect the electrodes 114 to the metal traces 126, which in turn connect to the cable connector 124. In an exemplary embodiment, nuts 122 may be employed on each of the screws 116 to enhance the electrical connection between the screws 116 and the metal traces 126. As explained previously, each electrode 114 may be individually removed and replaced by loosening its associated screw 116.

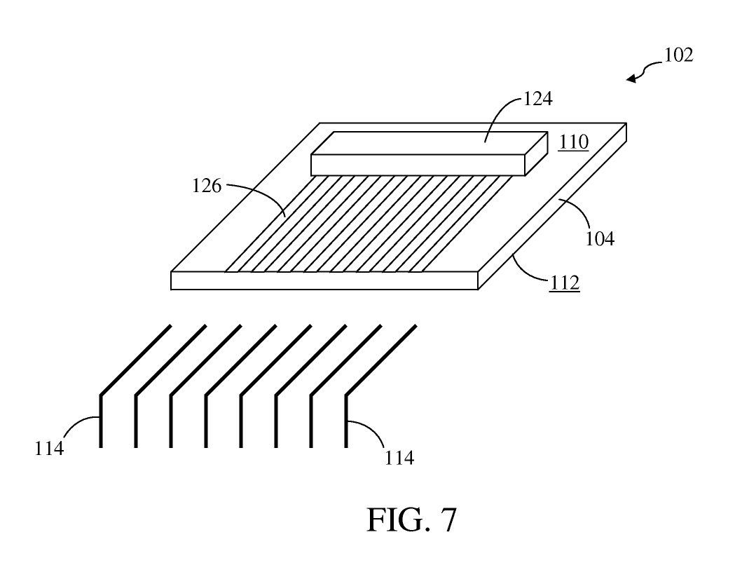

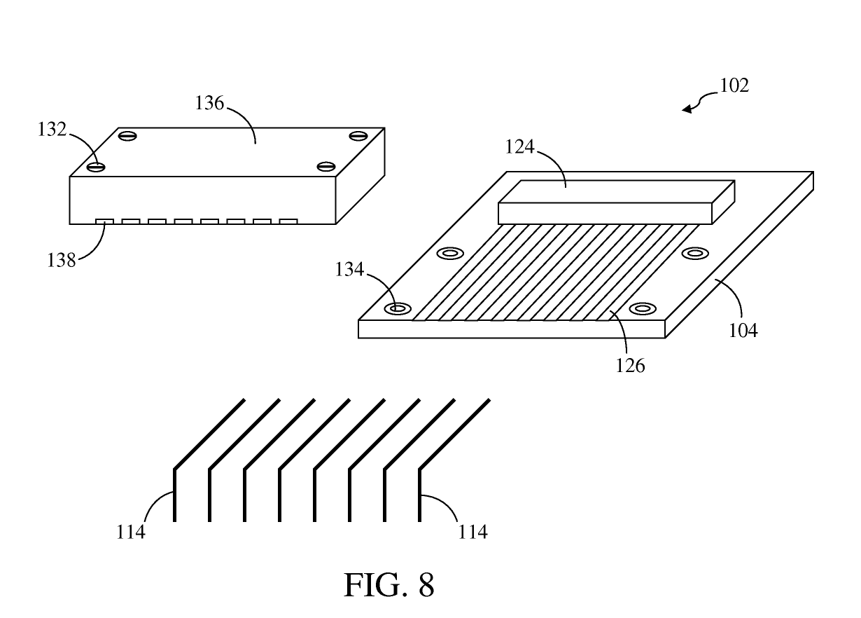

FIG. 7 is an exploded view of a multi-electrode holder 102, according to another embodiment of the invention. As illustrated in FIG. 7, electrodes 114 may be positioned in direct contact with metal traces 126 formed on an upper substrate surface 110 of the PCB 104. Further, as illustrated in FIG. 8, a shallow-grooved cover 136 may be employed to press each electrode 114 onto its associated metal trace 126. More specifically, the cover 136 having the very shallow grooves 138 applies pressure to the electrodes 114, and thereby holds the electrodes 114 down against their associated metal traces 126. Further, the cover 136 may be screwed down on the PCB 104 by using screws threaded in holes 132 of the cover 136 and corresponding holes 134 formed in the PCB 104. In an exemplary embodiment, loosening one or more screws allows for displacement of the cover 136 and removal and replacement of individual electrodes 114.

FIG. 9 is an exploded view of a multi-electrode holder 102, according to another embodiment of the invention. As illustrated in FIG. 9, channels 140 are formed (e.g., cut) in a lower layer 142 of a single PCB 104, and threaded through-holes may be formed, for the screws 116, through an upper layer 144 of the single PCB 104. In addition, nuts 122, such as surface mounted PEM nuts 122, may be employed to complete the electrical connection between the screws 116 and the metal traces 126 formed on the upper substrate surface 110 of the PCB 104. The electrodes 114 may then be positioned in the channels 140 and the two layers 142, 144 of the single PCB 104 may be coupled together in a normal PCB fabrication process (e.g., the two layers 142, 144 may be fused together). Alternatively, the two layers 142, 144 may first be coupled together and the electrodes 114 then slid into the channels 140. In either case, each of the electrodes 114 may be clamped to a bottom surface 146 of its corresponding channel 140 and be held in place by tightening its associated screw 116. In an exemplary embodiment, if an individual electrode 114 requires replacement, its corresponding screw 116 may be loosened and the electrode 114 may be removed and replaced.

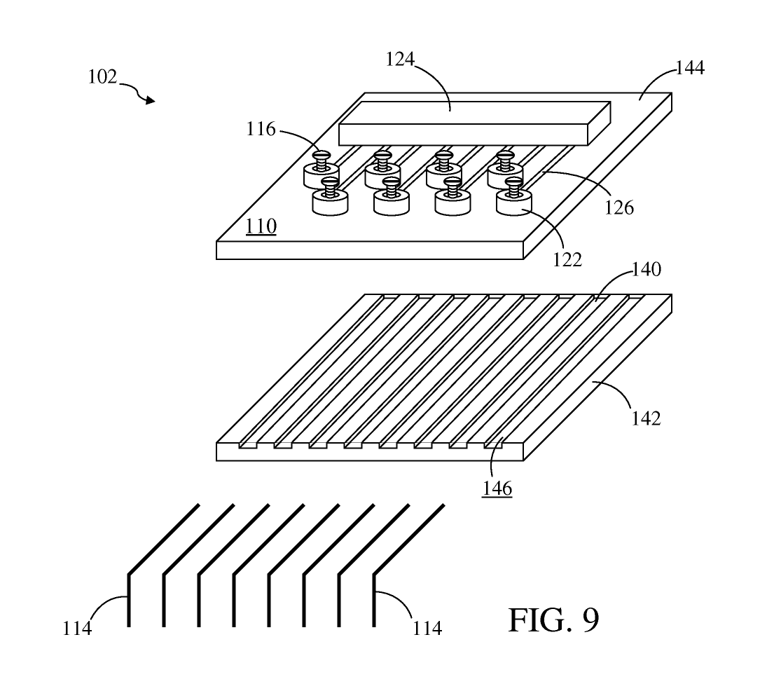

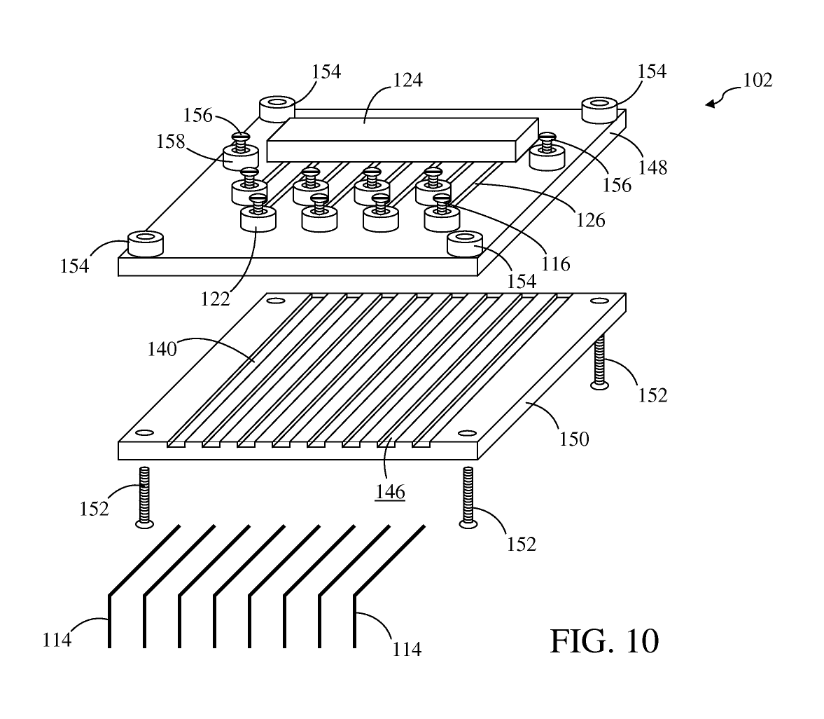

FIG. 10 is an exploded view of a multi-electrode holder 102, according to another embodiment of the invention. As illustrated in FIG. 10, instead of employing two layers of a single PCB 104 (as was done in the embodiment of FIG. 9), two PCBs may be employed—i.e., an upper board 148 and a lower board 150. A thickness of each board 148, 150 may vary from about 0.075 inches (1.91 mm) to about 0.125 inches (3.18 mm). The length of the boards 148, 150 (i.e., in the direction that the electrodes 114 lie) may be about 1.9 inches (48.3 mm) and the width of the boards 148, 150 may be about 2.1 inches (53.3 mm). In addition, channels 140 may be formed (e.g., cut) in the lower board 150, while independently actuatable contacts 116 (e.g., screws 116) may be placed within threaded through-holes formed in the upper board 148. The width of each channel 140 may vary from about 0.06 inches (1.52 mm) to about 0.085 inches (2.16 mm) and the depth of each channel 140 may vary from about 0.020 inches (0.51 mm) to about 0.05 inches (1.27 mm). Further, the nuts 122, such as surface mounted PEM nuts 122, may be employed to complete the electrical connection between the screws 116 and the metal traces 126 formed on the upper board 148. As explained previously, each screw 116 may be in electrical communication with the cable connector 124 positioned on the upper board 148 via an individual, electrically isolated, metal trace 126.

In addition, the upper and lower boards 148, 150 may be clamped together, for example via four corner mounted screws 152. As illustrated, both the upper and the lower boards 148, 150 may have corresponding holes to receive the corner mounted screws 152, and the upper board 148 may also have surface mounted PEM nuts 154 to tighten the screws 152. In addition, the upper board 148 may also include two ground screws 156 and corresponding surface mounted PEM nuts 158 for attaching ground reference wire(s). The diameter of the holes for the surface mounted PEM nuts 122, 154, and 158 may be about 0.15 inches (3.81 mm). Further, plated pads of about 0.24 inches (6.10 mm) in diameter may be provided for the surface mounted PEM nuts 122, 154 and 158. The diameter of the holes on the lower board 150 that receive the screws 152 may be about 0.09 inches (2.29 mm). Also, the pitch spacing between the channels 140 housing the electrodes 114 may vary from about 0.177 inches (4.5 mm) to about 0.2 inches (5.1 mm).

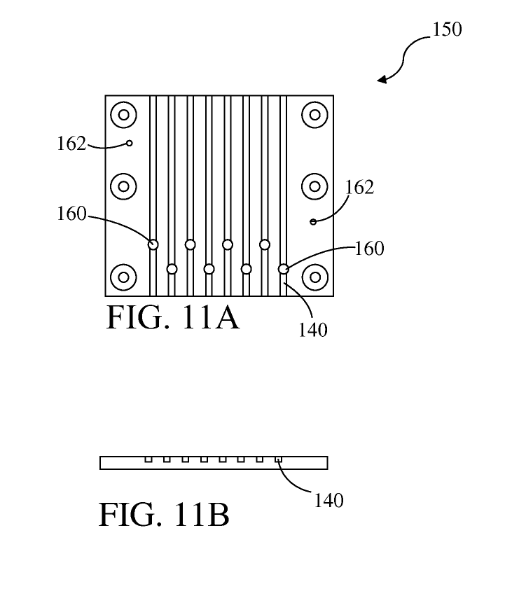

As explained with reference to previous embodiments, each screw 116 of the upper board 148 may be aligned with a channel 140 formed in the lower board 150 to individually clamp and make electrical contact with the electrode 114 placed in the corresponding channel 140. More specifically, the screws 116 may be tightened to clamp the electrodes 114 located in the associated channels 140. The electrodes 114 may be maintained in place in the corresponding channels 140 by friction. In addition, as in previous embodiments, when one of the electrodes 114 requires replacement, its corresponding screw 116 may be loosened and the electrode 114 may be removed and replaced. Optionally, as illustrated in FIG. 11A, each channel 140 formed in the lower board 150 (FIG. 11B is a side view thereof) may also include an enlarged circular section 160 for receiving the screws 116 of the upper board 148 associated with the corresponding channels 140. In an exemplary embodiment, the diameter of each enlarged circular section 160 may be about 0.09 inches (2.29 mm), and its depth may be about 0.06 inches (1.52 mm). In addition, both the upper board 148 and the lower board 150 may include two alignment holes 162 to enable a proper alignment of the upper board 148 with respect to the lower board 150. As will be understood by one of ordinary skill in the art, the dimensions provided herein are for exemplary purposes only and, thus, are non-limiting.

Each of the upper and lower boards 148, 150 may be manufactured using a PCB process. The upper board 148 may be, for example, a 1-layer board (e.g., metal traces 126 and other components thereof need only be placed on a single side of the board 148). The surface mounted PEM nuts 122, 154, and 158, for their part, may be easily affixed with a pick-and-place machine. In one embodiment, no plating process is required in the manufacture of the lower board 150.

The electrodes 114 employed in the various embodiments described herein may be made from, for example, platinum or silver/silver chloride, while the pitch spacing between the various, substantially parallel, channels 106, 140 housing the electrodes 114 is, in one embodiment, less than about 0.2 inches (i.e., less than about 5.1 mm). For example, the pitch spacing between the channels 106, 140 may be about 0.177 inches (i.e., about 4.5 mm). This spacing allows each channel 106, 140 to be electrically isolated from another. In addition, each channel 106, 140 may itself be sized, in cross-section, to receive an electrode 114 in close fitting sliding relation thereto. Each electrode 114 may be, for example, 0.008 inches (0.20 mm) in diameter.

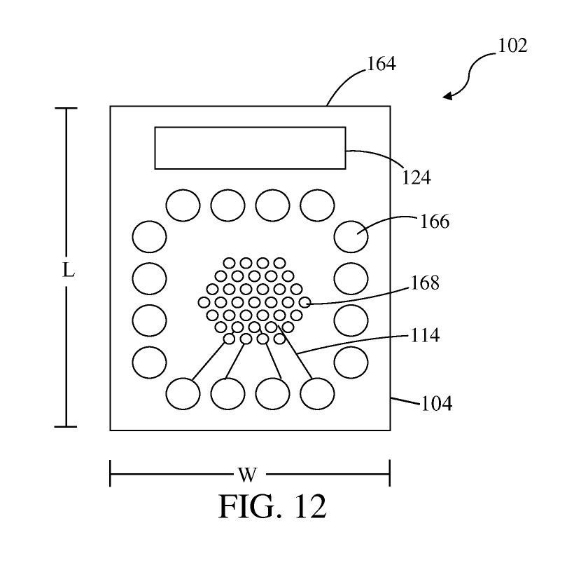

FIG. 12 illustrates a multi-electrode holder 102 that features a matrix configuration, according to an embodiment of the invention. As illustrated in FIG. 12, the multi-electrode holder 102 may feature a single substrate 104, such as a PCB. The length “L” of the PCB 104 may vary from about 2.06 inches (52.3 mm) to about 2.52 inches (64.0 mm), the width “W” of the PCB 104 may vary from about 1.58 inches (40.1 mm) to about 1.84 inches (46.7 mm), and the thickness of the PCB 104 may be in the range of about 0.125 inches (3.18 mm). The substrate 104 defines a plurality of threaded through-holes 166 for receiving a plurality of actuatable contacts 116 (e.g., threaded fasteners, such as screws 116). The threaded through-holes 166 may extend through the PCB 104, such that the actuatable contacts 116 may be screwed through the PCB 104. The pitch spacing of the threaded through-holes 166 may vary from about 0.276 inches (7 mm) to about 0.315 inches (8 mm). As illustrated, the PCB 104 also defines a plurality of electrode through-holes 168. The diameter of each electrode through hole 168 may vary from about 0.020 inches (0.5 mm) to about 0.040 inches (1 mm). In FIG. 12, the electrode through holes 168 are arranged in a hexagonal pattern.

Each electrode through-hole 168 is capable of receiving the end of a single electrode 114 therethrough. For example, an actuatable contact 116 may be screwed down through a first threaded through-hole 166 to impinge a first end of a malleable electrode 114 between the actuatable contact 116 and the PCB 104. A second end of that malleable electrode 114 may then be bent to extend through a first electrode through-hole 168 so as to exit the underside of the PCB 104. Upon exiting an underside of the PCB 104, the electrode 114 may be employed to sense the electrical behavior of a biological cell and/or cell membrane, as described above.

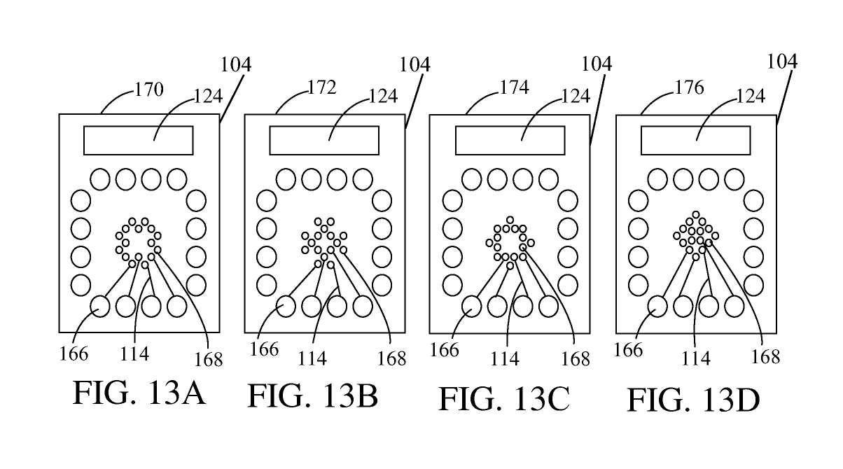

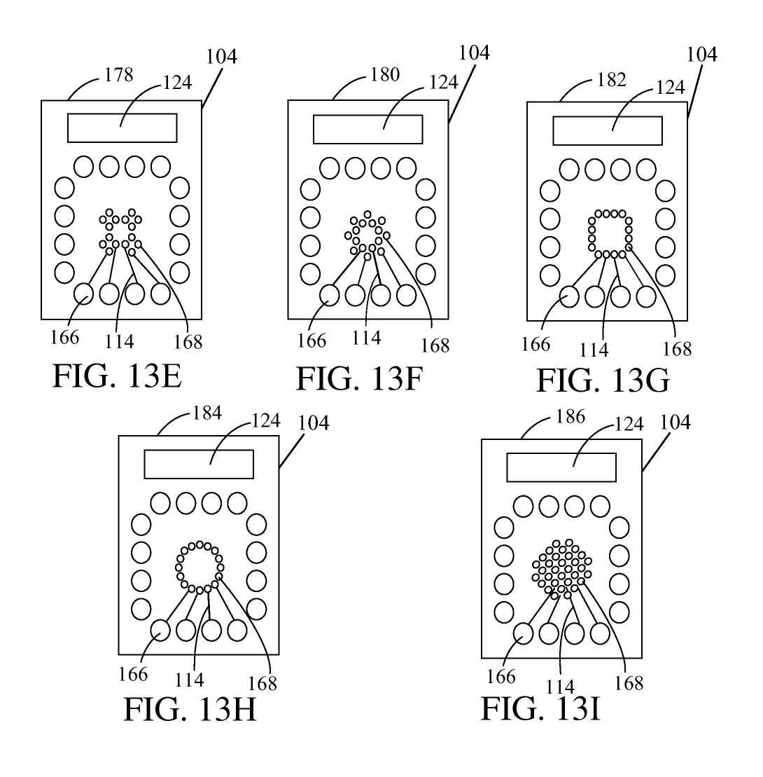

With reference still to FIG. 12, the exemplary multi-electrode holder 102 is shown to feature sixteen threaded through-holes 166 and a larger number of electrode through-holes 168. In this fashion, because the electrodes 114 are malleable, a user may optionally move the electrodes 114 around and place them through different electrode through-holes 168 (i.e., the user may configure the multi-electrode holder 102 as desired). In certain embodiments, it is important not to cross the individual electrodes 114 (i.e., so as to avoid shorting the electrodes 114). As depicted in FIG. 12, the multi-electrode holder's “hexagonal” pattern 164 facilitates this goal, as do the other patterns illustrated in FIGS. 13A-13I.

As will be understood by one of ordinary skill in the art, although only four electrodes 114 are shown (in each of the patterned PCBs 104 illustrated in FIGS. 12 and 13A-13I) to extend from the actuatable contacts 116 at the threaded through-holes 166 to the electrode through-holes 168, sixteen electrodes 114 (or any other number of electrodes 114 suitable for a particular application) may in fact extend from the actuatable contacts 116 at the threaded through-holes 166 to the electrode through-holes 168. In addition, each PCB 104 may feature fewer or more than sixteen actuatable contacts 116 and threaded through-holes 166, and the number of electrode through-holes 168 featured in each PCB 104 may be greater than (as illustrated in square grid pattern 186 of FIG. 13I, and hexagonal pattern 164 of FIG. 12), equal to (as illustrated in patterns 170, 172, 174, 176, 178, 180, 182, and 184 of FIGS. 13A-13H), or even less than the number of the threaded through-holes 166 featured therein. In an exemplary embodiment, each PCB 104 may also include one or more threaded through-holes to receive the aforedescribed ground screws.

Further, although not explicitly illustrated in the exemplary PCBs 104 of FIGS. 12 and 13A-13I, a conductive PCB trace 126 may extend from each threaded through-hole 166 to the multi-electrode holder's cable connector 124. Additionally, where screws 116 are employed as the actuatable contacts 116, a nut 122 may also be optionally employed on each of the screws 116 in order to enhance the electrical connection between the screws 116 and the traces 126 formed on the PCB 104. As explained previously, the cable connector 124 may communicate with an amplifier through a cable.

As will be apparent to one of ordinary skill in the art, each electrode 114 of the multi-electrode holders 102 depicted in FIGS. 12 and 13A-13I may be individually removed and replaced—the electrodes 114 do not all need to be removed and replaced at the same time.

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein are not mutually exclusive and can exist in various combinations and permutations, even if such combinations or permutations were not made express herein, without departing from the spirit and scope of the invention. In fact, variations, modifications, and other implementations of what was described herein, including varying dimensions, will occur to those of ordinary skill in the art without departing from the spirit and the scope of the invention. As such, the invention is not to be defined only by the preceding illustrative description.

What is claimed is:

1. A multi-electrode holder adapted for use to electrically connect a plurality of replaceable electrodes to a cable, the holder comprising:
a substrate having a plurality of channels formed therein for receiving at least two electrodes;
a plurality of independently actuatable contacts, each contact aligned with a channel for retaining an electrode when disposed therein and for making electrical contact with such electrode; and
a connector in electrical communication with the plurality of contacts for connection to a cable.

2. The multi-electrode holder of claim 1, wherein the substrate comprises:
an upper substrate surface; and
a lower substrate surface, wherein the channels are formed therebetween and each channel is adapted to receive an electrode therein.

3. The multi-electrode holder of claim 2, wherein each channel is sized to receive an electrode in close fitting sliding relation and in electrical isolation from other channels.

4. The multi-electrode holder of claim 2, wherein the upper substrate and the lower substrate are clamped together.

5. The multi-electrode holder of claim 1, wherein at least one contact of the plurality of independently actuatable contacts utilizes friction to maintain a clamping force on an electrode when disposed in an associated channel.

6. The multi-electrode holder of claim 5, wherein the at least one contact comprises a threaded fastener.

7. The multi-electrode holder of claim 1, further comprising at least two electrodes disposed in respective channels.

8. The multi-electrode holder of claim 7, wherein the at least two electrodes comprise material selected from the group consisting of Ag—AgCl and Pt.

9. The multi-electrode holder of claim 1, wherein the channels have a pitch spacing therebetween of no more than about 0.2 inches.

10. The multi-electrode holder of claim 1, wherein the connector is in electrical communication with the plurality of contacts using conductive traces formed on the substrate.

11. A multi-electrode holder adapted for use to electrically connect a plurality of replaceable electrodes to an amplifier cable, the holder comprising:
a substrate comprising:
i) an upper board; and
ii) a lower board, wherein at least one of the upper board and the lower board has a plurality of substantially parallel closely spaced channels formed therein, each channel for receiving an electrode;
a plurality of independently actuatable threaded contacts mounted to the substrate, each threaded contact aligned with a channel for retaining an electrode when disposed therein and for making electrical contact with such electrode;
a connector mounted to the substrate comprising a plurality of electrical contacts for mating with a cable; and
a plurality of conductive paths providing isolated electrical communication between respective threaded contacts and connector electrical contacts.

12. The multi-electrode holder of claim 11 further comprising an electrode disposed in each channel.

13. A multi-electrode holder adapted for use to electrically connect a plurality of replaceable electrodes to a cable, the holder comprising:
a substrate having a plurality of electrode through-holes formed therethrough for receiving at least two electrodes;
a plurality of independently actuatable contacts, each contact for retaining an electrode and for making electrical contact with such electrode; and
a connector in electrical communication with the plurality of contacts for connection to a cable.

14. The multi-electrode holder of claim 13, wherein the plurality of electrode through-holes are patterned to receive the electrodes in electrical isolation from each other.

15. The multi-electrode holder of claim 13, wherein at least one of the actuatable contacts is a threaded fastener.

16. The multi-electrode holder of claim of claim 13 further comprising the at least two electrodes, and wherein each electrode comprises a material selected from the group consisting of Ag—AgCl and Pt.

17. The multi-electrode holder of claim 13, wherein the connector is in electrical communication with the plurality of contacts using conductive traces formed on the substrate.
